(19) United States
(12) Patent Application Publication
(10) Pub. No.: US 2026/0227339 A1
(43) Pub. Date: Aug. 6, 2026

(54) PEELING/FLAKING SPECIFICATION DEVICE, METHOD, AND PROGRAM

(71) Applicant: FUJIFILM Corporation, Tokyo (JP)

(72) Inventor: Yosuke NISHIURA, Kanagawa (JP)

(73) Assignee: FUJIFILM Corporation, Tokyo (JP)

(21) Appl. No.: 19/577,369

(22) Filed: Mar. 25, 2026

Related U.S. Application Data
(63) Continuation of application No. PCT/JP2024/031719, filed on Sep. 4, 2024.

(30) Foreign Application Priority Data
Sep. 25, 2023 (JP) 2023-161582

(51) Int. Cl. G01N 21/88; G01N 21/95

(52) U.S. Cl. CPC G01N 21/8806; G01N 21/95

(57) ABSTRACT

Provided are a peeling/flaking specification device, method, and program capable of specifying a peeling/flaking portion on a surface of concrete or the like of a building. A processor of the peeling/flaking specification device acquires three-dimensional measurement data of a surface of a building measured by a three-dimensional measurement device such as a LiDAR (step S10). The processor compares the three-dimensional measurement data with reference surface data of the building to detect a depressed portion on the surface of the building (step S20). The processor determines whether or not the detected depressed portion is depressed beyond a first threshold value and whether or not the depressed portion is fissuring (steps S30, S40). In a case where the determination is made that the depressed portion is depressed beyond the first threshold value and is not the fissuring, the depressed portion is specified as the peeling/flaking portion (step S50).

### CROSS-REFERENCE TO RELATED APPLICATIONS

The present application is a Continuation of PCT International Application No. PCT/JP2024/031719 filed on September 4, 2024 claiming priority under 35 U.S.C §119(a) to Japanese Patent Application No. 2023-161582 filed on September 25, 2023. Each of the above applications is hereby expressly incorporated by reference, in its entirety, into the present application.

### BACKGROUND OF THE INVENTION

### 1. Field of the Invention

The present invention relates to a peeling/flaking specification device, method, and program, and more particularly to a technique of specifying a peeling/flaking portion on a surface of concrete or the like of a building.

### 2. Description of the Related Art

In the related art, inspection of buildings such as a tunnel and a bridge is generally performed by an inspector patrolling a site, and during the patrol, the inspector may find a flaking location or a flaked-off object (concrete piece) on a surface of a building.

However, since the patrol is dependent on a person and is not always performed during a bright time slot, flaking may be overlooked. In order to avoid overlooking, the number of inspectors is increased and the patrol is performed by a plurality of inspectors, but this requires persons and money and is not accurate.

In recent years, new techniques described in JP2016-006398A to JP2006-105680A and the like have been developed and introduced into infrastructure inspection, and digital transformation (DX) of the person-dependent inspection is expected.

In a flaking prediction diagnosis method described in JP2016-006398A, an infrared camera captures an infrared thermal image of a surface of a concrete building, an outside air temperature near the surface thereof is measured at the same time, a peeled portion temperature difference as a temperature difference between a sound portion and a peeled portion and a measurement temperature environment as a difference between a surface temperature of the sound portion and the outside air temperature are calculated based on the infrared thermal image and the outside air temperature, a temperature environment coefficient as a ratio of the calculated peeled portion temperature difference to the calculated measurement temperature environment is calculated, and a risk degree of flaking of cover concrete (concrete from reinforcing bar surface to concrete surface) is quantitatively evaluated according to the temperature environment coefficient.

In an inspection method described in JP2020-098098A, a hammer device for inspection strikes a testing target, and a state of the testing target is determined based on time point history data of sound pressure generated by the strike.

In a non-destructive testing method for a concrete building described in JP2006-105680A, an ultrasonic transmitter and receiver are brought into contact with an inundated portion of the concrete building that is partially or entirely inundated, the receiver detects a resonance vibration of the concrete building while allowing a transverse wave ultrasonic wave to be incident on the concrete building from the transmitter, and a rear surface damage and/or an internal damage of the concrete building are determined based on a detection waveform of the receiver.

### SUMMARY OF THE INVENTION

However, none of the techniques described in JP2016-006398A to JP2006-105680A specify a peeling/flaking portion on the surface of concrete or the like of the building. In particular, the technique described in JP2016-006398A is a method for quantitatively evaluating the risk degree of the cover concrete flaking, and is not a technique of actually specifying a location where the cover concrete has flaked and peeled.

One embodiment according to the technique of the present disclosure provides a peeling/flaking specification device, method, and program capable of specifying a peeling/flaking portion on a surface of concrete or the like of a building.

According to a first aspect of the present invention, there is provided a peeling/flaking specification device including a processor, and a memory that stores a program to be executed by the processor, in which the processor is configured to acquire three-dimensional measurement data of a surface of a building measured by a measurement device, compare the three-dimensional measurement data with reference surface data of the building to detect a depressed portion on the surface of the building, and specify, in a case where determination is made that the depressed portion is depressed beyond a first threshold value and the depressed portion is not fissuring, the depressed portion as a peeling/flaking portion on the surface of the building.

According to the first aspect of the present invention, the three-dimensional measurement data of the surface of the building is compared with the reference surface data of the building to detect the depressed portion on the surface of the building. In order to distinguish the detected depressed portion from the depressed portion at a time of construction, the depressed portion depressed beyond the first threshold value is specified. Further, the determination is made whether the depressed portion depressed beyond the first threshold value is the depressed portion due to the peeling/flaking portion or the depressed portion due to the fissuring to finally specify the peeling/flaking portion.

According to a second aspect of the present invention, in the peeling/flaking specification device according to the first aspect, it is preferable that the processor is configured to measure a lateral width and a longitudinal width of the depressed portion, and determine that the depressed portion is not the fissuring in a case where a short width of the lateral width or the longitudinal width exceeds a second threshold value.

According to a third aspect of the present invention, in the peeling/flaking specification device according to the first aspect, it is preferable that the processor is configured to measure an area of the depressed portion, and determine that the depressed portion is not the fissuring in a case where the area exceeds a third threshold value.

According to a fourth aspect of the present invention, in the peeling/flaking specification device according to the first aspect, it is preferable that the processor is configured to acquire a captured image of the building captured by an imaging device, detect the fissuring in the building based on the captured image, and determine whether or not the depressed portion is the fissuring based on a detection result of the fissuring. This is because the fissuring is preferably detected based on the captured image rather than from the three-dimensional measurement data.

According to a fifth aspect of the present invention, in the peeling/flaking specification device according to any one of the first to fourth aspects, it is preferable that the reference surface data is surface data obtained by averaging unevenness of the surface of the building indicated by the three-dimensional measurement data, or surface data on design of the building.

According to a sixth aspect of the present invention, in the peeling/flaking specification device according to any one of the first to fifth aspects, it is preferable that the memory stores the three-dimensional measurement data of the surface of the building measured by the measurement device each time the building is inspected, and the processor is configured to acquire a plurality of pieces of three-dimensional measurement data of the surface of the building measured for each inspection, acquire difference data of the same measurement point on the surface of the building based on the plurality of pieces of three-dimensional measurement data, and detect at least the depressed portion of a bulging portion or the depressed portion on the surface of the building based on the difference data. In this case, among the different pieces of three-dimensional measurement data at the time of inspection used to acquire the difference data, early three-dimensional measurement data at the time of inspection serves as the reference surface data for late three-dimensional measurement data at the time of inspection.

According to a seventh aspect of the present invention, in the peeling/flaking specification device according to the sixth aspect, it is preferable that the processor is configured to specify, in a case where the bulging portion and the depressed portion at the same portion on the surface of the building are detected in a chronological order of the inspection, the depressed portion as the peeling/flaking portion on the surface of the building. The bulging portion is a candidate portion for the peeling/flaking portion, and in a case where the bulging portion changes into the depressed portion, the depressed portion can be specified as the peeling/flaking portion.

According to an eighth aspect of the present invention, in the peeling/flaking specification device according to the sixth aspect, it is preferable that the processor is configured to specify, in a case where a change in the difference data turns negative, in a case where the change in the difference data turns from positive to negative, or in a case where the change in the difference data decreases beyond a threshold value, the depressed portion as the peeling/flaking portion on the surface of the building.

According to a ninth aspect of the present invention, in the peeling/flaking specification device according to any one of the first to eighth aspects, it is preferable that the processor is configured to display the specified peeling/flaking portion in an identifiable manner on a screen of a display that displays the three-dimensional measurement data, surface data on design of the building, or a captured image of the building captured by an imaging device. A user (inspector) can check, on the screen of the display, which location of the building has the peeling/flaking portion.

According to a tenth aspect of the present invention, in the peeling/flaking specification device according to any one of the first to ninth aspects, it is preferable that the measurement device includes a LiDAR or a stereo camera.

According to an eleventh aspect of the present invention, in the peeling/flaking specification device according to the tenth aspect, it is preferable that the three-dimensional measurement data is measured by the LiDAR of a frequency modulated continuous wave (FMCW) type. With the above, it is possible to detect a surface property of the building that cannot be checked visually.

According to a twelfth aspect of the present invention, in the peeling/flaking specification device according to any one of the first to eleventh aspects, it is preferable that a material of the surface of the building includes concrete or a concrete repair material.

According to a thirteenth aspect of the present invention, there is provided a peeling/flaking specification method for specifying peeling/flaking on a surface of a building by a processor, the method including acquiring three-dimensional measurement data of a surface of a building measured by a measurement device, comparing the three-dimensional measurement data with reference surface data of the building to detect a depressed portion on the surface of the building, and specifying, in a case where determination is made that the depressed portion is depressed beyond a first threshold value and the depressed portion is not fissuring, the depressed portion as a peeling/flaking portion on the surface of the building.

According to a fourteenth aspect of the present invention, in the peeling/flaking specification method according to the thirteenth aspect, it is preferable that the processor is configured to measure a lateral width and a longitudinal width of the depressed portion, and determine that the depressed portion is not the fissuring in a case where a short width of the lateral width or the longitudinal width exceeds a second threshold value.

According to a fifteenth aspect of the present invention, in the peeling/flaking specification method according to the thirteenth aspect, it is preferable that the processor is configured to measure an area of the depressed portion, and determine that the depressed portion is not the fissuring in a case where the area exceeds a third threshold value.

According to a sixteenth aspect of the present invention, in the peeling/flaking specification method according to the thirteenth aspect, it is preferable that the processor is configured to acquire a captured image of the building captured by an imaging device, detect the fissuring in the building based on the captured image, and determine whether or not the depressed portion is the fissuring based on a detection result of the fissuring.

According to a seventeenth aspect of the present invention, there is provided a peeling/flaking specification program for specifying peeling/flaking on a surface of a building, the program causing a computer to execute, a function of acquiring three-dimensional measurement data of a surface of a building measured by a measurement device, a function of comparing the three-dimensional measurement data with reference surface data of the building to detect a depressed portion on the surface of the building, and a function of specifying, in a case where determination is made that the depressed portion is depressed beyond a first threshold value and the depressed portion is not fissuring, the depressed portion as a peeling/flaking portion on the surface of the building.

According to the present invention, it is possible to specify the peeling/flaking portion on the surface of the concrete or the like of the building with high accuracy.

### BRIEF DESCRIPTION OF THE DRAWINGS

FIG. 1 is a graph showing a relationship between a lapse of time after construction of a building and a surface displacement and peeling/flaking of the building, and is a diagram showing an example of a cross section of the building at each time of inspection.

FIG. 2 is a schematic diagram of an inspection system of the building including a peeling/flaking specification device according to the present invention.

FIG. 3 is an external view including an FMCW type LiDAR of one embodiment of a three-dimensional measurement device.

FIG. 4 is a diagram showing an embodiment in which a stereo camera measures a three-dimensional shape of a surface of the building.

FIG. 5 is a cross-sectional view of the vicinity of the surface of the building, which shows an example of a mechanism in which the surface of the building is peeled off.

FIG. 6 is a cross-sectional view of the vicinity of the surface of the building, which shows another example of the mechanism in which the surface of the building is peeled off.

FIG. 7 is a block diagram showing an embodiment of a hardware configuration of the peeling/flaking specification device according to the present invention.

FIGS. 8A and 8B are diagrams showing a method for specifying a peeling/flaking portion on the surface of the building.

FIG. 9 is a captured image of a building including the peeling/flaking portion and a fissuring portion.

FIG. 10 is a diagram showing an example of a surface property of the building, based on a large number of measurement points (measurement points distributed two-dimensionally) measured by the three-dimensional measurement device.

FIG. 11 is a diagram showing another example of the surface property of the building, based on a large number of measurement points measured by the three-dimensional measurement device.

FIGS. 12A, 12B, 12C and 12D are diagrams showing another method for detecting a depressed portion on the surface of the building.

FIG. 13 is a diagram showing an example of a screen of a display on which the peeling/flaking portion and the like are displayed.

FIG. 14 is a flowchart showing an embodiment of a peeling/flaking specification method according to the present invention.

### DESCRIPTION OF THE PREFERRED EMBODIMENTS

Preferred embodiments of a peeling/flaking specification device, method, and program according to the present invention will now be described with reference to accompanying drawings.

### Outline of present invention

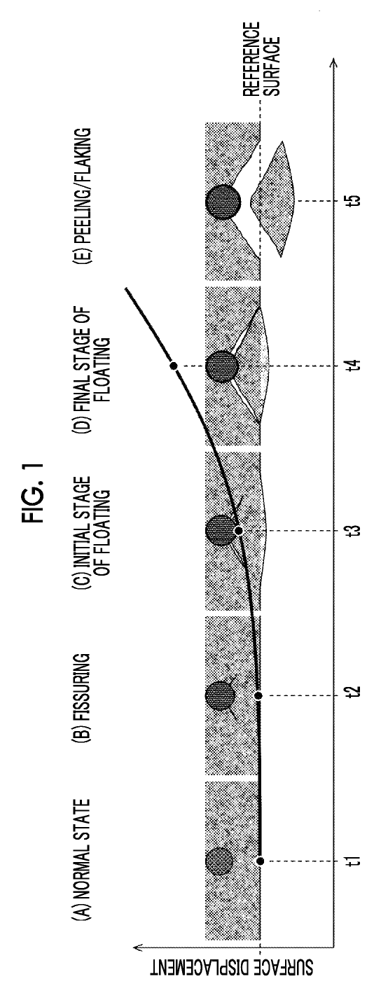

FIG. 1 is a graph showing a relationship between a lapse of time after construction of a building and a surface displacement and peeling/flaking of the building, and is a diagram showing an example of a cross section of the building at each time of inspection.

In FIG. 1, the displacement of the surface of the building is measured at an inspection start point in time (measurement start point in time at a time of construction) t1 of the building and at each inspection point in time (t2, t3, t4, t5, ...) after the measurement start point in time. With a comparison between displacements at the same position on the surface of the building, it is possible to observe a location where the surface bulges with a lapse of time from the construction of the building.

In the example shown in FIG. 1, the building at the measurement start point in time t1 is in an (A) normal state, but the surface of the building slightly bulges due to a deterioration phenomenon ((B) fissuring) of the building at the inspection point in time t2. The bulging at this timing is not able to be checked by visual observation or the like. The “fissuring” is often caused by corrosion and thickening of a steel material (reinforcing bar) inside the building.

In a (C) initial stage of floating shown at the inspection point in time t3, the “fissuring” also progresses as the corrosion of the reinforcing bar progresses, and the surface of the building bulges (“floating” occurs).

In a (D) final stage of floating shown at the inspection point in time t4, the “fissuring” further progresses and reaches the surface of the building, and the “floating” also further increases.

The inspection point in time t5 indicates a point in time at which cover concrete (concrete from reinforcing bar surface to concrete surface) falls ((E) peeling/flaking).

In the example shown in FIG. 1, it can be seen that the displacement (bulging amount) of the surface of the building, which is measured for each inspection, gradually increases and the cover concrete peels off and flakes off.

The flaking phenomenon causes abnormalities on the concrete surface regardless of the cause. In a case where highly accurate surface displacement measurement is made, even the slightest flaking can be found more precisely without being overlooked.

In the present invention, three-dimensional measurement data indicating the surface displacement of the building is acquired, and a depressed portion on the surface of the building is detected based on the three-dimensional measurement data. With a comparison between the three-dimensional measurement data and a reference surface (reference surface data), this depressed portion can be detected.

Further, in order to distinguish between unevenness (depressed portion) on the surface of the building at the time of construction and the depressed portion that is a peeling/flaking portion, the depressed portion exceeding a first threshold value is detected. Accordingly, the depressed portion caused by slight unevenness on the surface of the building at the time of construction is eliminated.

In a case where determination is made that the depressed portion exceeding the first threshold value is not the depressed portion caused by the fissuring, the depressed portion is specified as the peeling/flaking portion.

### Outline configuration of inspection system

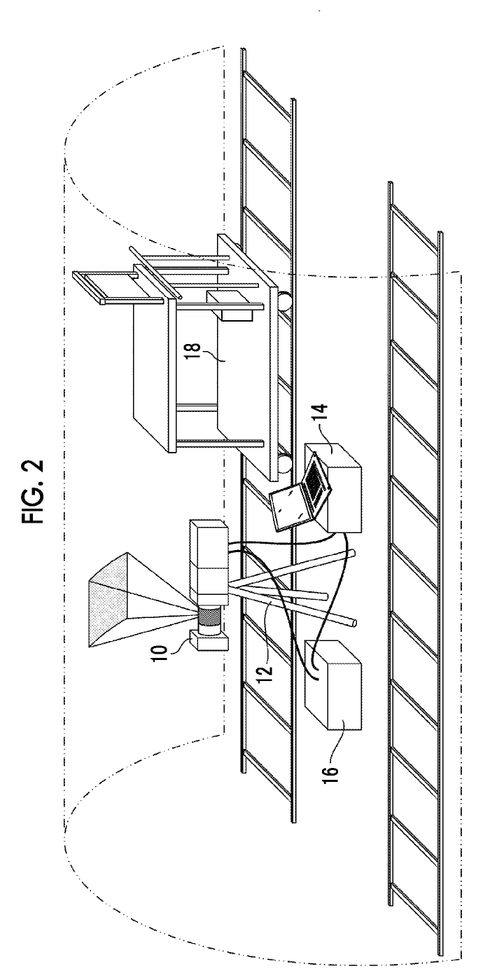

FIG. 2 is a schematic diagram of an inspection system of the building including the peeling/flaking specification device according to the present invention.

The inspection system shown in FIG. 2 inspects a tunnel of a railroad, and comprises a three-dimensional measurement device 10, a data processing device 14, and a power supply device 16.

The three-dimensional measurement device 10 is mounted on a tripod 12, but may be mounted on a carriage 18 that travels on a railroad track.

The three-dimensional measurement device 10 is a light detection and ranging (LiDAR) in the present example, and is particularly a frequency modulated continuous wave (FMCW) type LiDAR capable of performing distance measurement in an order of several hundred μm. However, the present invention is not limited to a case where distance measurement data (three-dimensional measurement data) measured by the FMCW type LiDAR is used.

### Three-dimensional measurement device

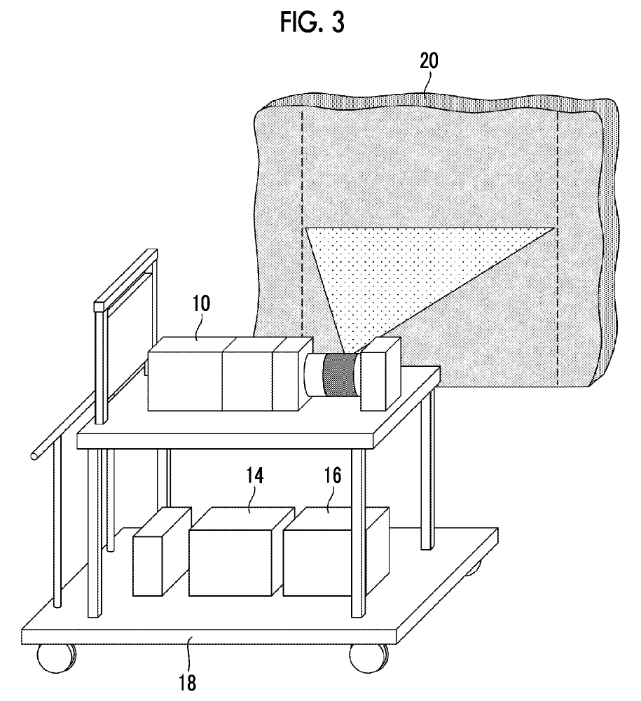

FIG. 3 is an external view including the FMCW type LiDAR of one embodiment of the three-dimensional measurement device.

In FIG. 3, the three-dimensional measurement device 10 is mounted on the carriage 18 that travels on the railroad track as shown in FIG. 2 to measure a distance to a surface of the tunnel, which is a railroad building.

The carriage 18 is mounted with the data processing device 14 and the power supply device 16, in addition to the three-dimensional measurement device 10. The power supply device 16 supplies power to the three-dimensional measurement device 10 and the data processing device 14.

The three-dimensional measurement device 10 measures a distance to a wall surface (surface) 20 of the tunnel to acquire the three-dimensional measurement data indicating a shape of the wall surface 20 of the tunnel.

In the example shown in FIG. 3, the three-dimensional measurement device 10 scans the wall surface 20 shown in FIG. 3 in a left-right direction (main scanning direction) at a high speed with laser light of the FMCW type, and causes a scanning line to move in an up-down direction (sub-scanning direction) of the wall surface 20 to perform the scanning. Accordingly, the distance measurement is performed from a measurement head of the three-dimensional measurement device 10 to a large number of measurement points on each scanning line of the laser light. Three-dimensional data of a polar coordinate system consisting of an irradiation direction of the laser light and a measured distance is converted into three-dimensional data of a rectangular coordinate system to acquire three-dimensional measurement data indicating the shape of the wall surface 20. In the present example, the three-dimensional measurement data (point group data) of a large number of measurement points is acquired as the three-dimensional measurement data.

It is considered that the three-dimensional measurement device 10 performs measurement of a minute uneven shape of the wall surface 20 under the following conditions. ▪ Measurement accuracy: 50 μm ▪ Measurement distance: 2 m to 7 m ▪ Measurement speed: 10 m²/sec in terms of area (speed of laser light is equivalent to 4000 rpm)

Further, for example, the three-dimensional measurement device 10 acquires the three-dimensional data of the wall surface 20 at a constant interval during the movement of the carriage 18. However, the three-dimensional data is preferably acquired such that measurement regions of the three-dimensional data acquired at each interval partially overlap. This is for panorama composition of the three-dimensional data acquired at each interval.

The three-dimensional measurement device 10 can achieve the measurement accuracy and the like described above with the use of the FMCW type LiDAR, but the conditions such as the measurement accuracy of the three-dimensional measurement data required in the present invention are not limited to the above example. Various types of three-dimensional measurement devices can be employed without being limited to the FMCW type LiDAR.

For example, a time of flight (TOF) type LiDAR that measures a flight time of pulse-projected light to measure the distance to the wall surface 20 can be used instead of the FMCW type LiDAR. Further, the three-dimensional shape of the wall surface 20 can be measured by a stereo camera.

FIG. 4 is a diagram showing an embodiment in which a stereo camera measures three-dimensional shape of the surface of the building.

The stereo camera shown in FIG. 4 consists of a left camera 30L and a right camera 30R, and measures the distance to the wall surface 20 of an imaging target by a triangulation method.

In addition, various three-dimensional measurement devices can be employed as the three-dimensional measurement device that measures the distance to the wall surface 20 (that is, three-dimensional measurement data of wall surface), such as a laser radar three-dimensional shape measurement device described in JP1997-297014A (JP-H9-297014A), a measurement device by an optical cutting method using an imaging device and a slit laser light projector described in 2016-31249A, an FM laser radar type distance measurement device described in JP3194586B, and an optical distance meter described in JP3583906B.

The three-dimensional shape of the wall surface 20 of the tunnel is measured by the three-dimensional measurement device 10 at a time of measurement start (construction) of the tunnel and at a time of regular inspection after the construction. The measured three-dimensional measurement data of the wall surface is stored in a storage device in the data processing device 14 or an external storage device at the time of measurement start and at the time of regular inspection.

### Peeling mechanism of surface material of building

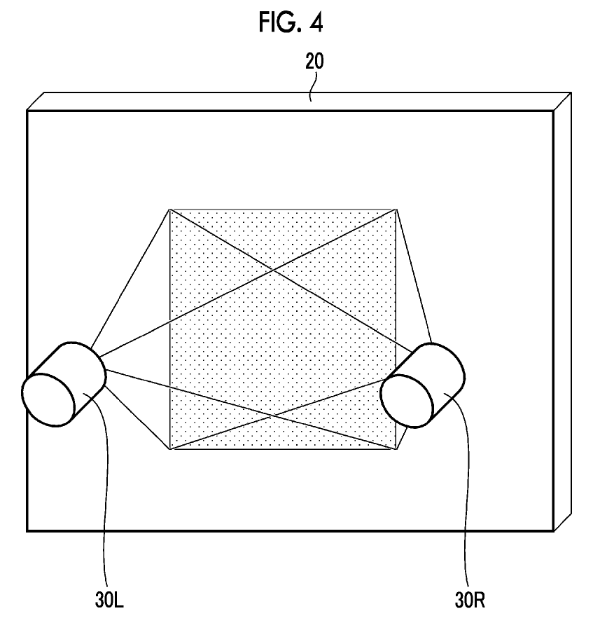

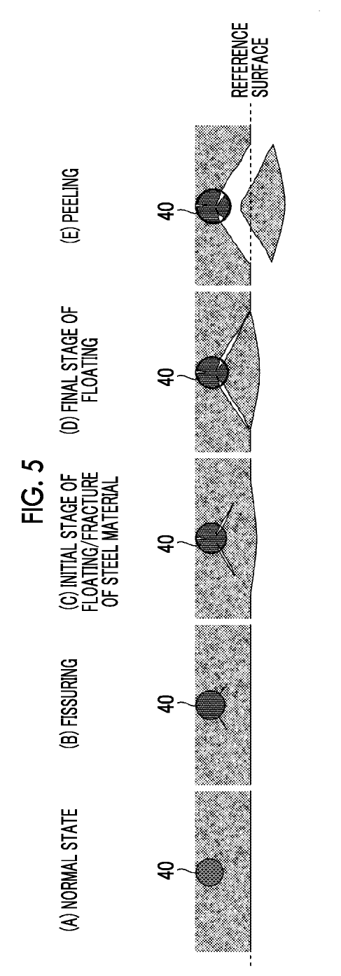

FIG. 5 is a cross-sectional view of the vicinity of the surface of the building, which shows an example of a mechanism in which the surface of the building is peeled off.

The “(A) normal state” of FIG. 5 refers to a state of being normal, for example, at the time of construction of the building. The surface in this state is defined as a reference surface. In FIGS. 5,40 is a steel material (reinforcing bar).

The “(B) fissuring”, “(C) initial stage of floating/fracture of steel material”, “(D) final stage of floating”, and “(E) peeling” of FIG. 5 occur due to the corrosion (for example, salt damage or water leakage) of the reinforcing bar 40 or the like, and occur according to the number of years elapsed since the time of construction of the tunnel.

In “(C) Initial stage of floating/fracture of steel material” of FIG. 5 and subsequent stages, the surface of the building is gradually higher than the reference surface (“floating” occurs), and the cover concrete is peeled off.

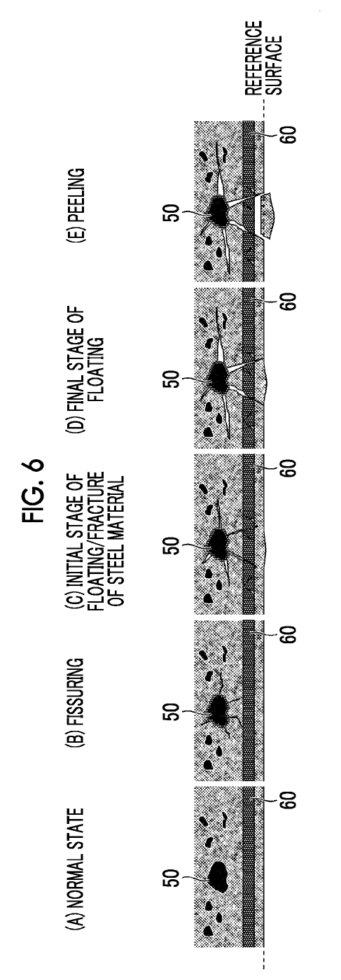

FIG. 6 is a cross-sectional view of the vicinity of the surface of the building, which shows another example of the mechanism in which the surface of the building is peeled off.

The “(A) normal state” of FIG. 6 refers to a state of being normal, for example, at the time of construction of the building. The surface in this state is defined as a reference surface. In FIGS. 6,50 indicates a reactive aggregate, and 60 indicates a steel material.

The “(B) fissuring”, “(C) initial stage of floating/fracture of steel material”, “(D) final stage of floating”, and “(E) peeling” of FIG. 6 occur due to the deterioration of concrete strength (for example, alkali reaction of the reactive aggregate 50) or the like, and occur according to the number of years elapsed since the time of construction.

In “(C) Initial stage of floating/fracture of steel material” of FIG. 6 and subsequent stages, the surface of the building is gradually higher than the reference surface (“floating” occurs), and the cover concrete from a surface of the steel material 60 to the surface is peeled off.

As shown in FIG. 5 and FIG. 6, in a case where “floating” occurs due to the change over time in the surface of the building, “peeling” occurs in the future. This applies to all cases regardless of the cause of “floating”. That is, the presence or absence, material, and shape of the reinforcing bar, a material and shape of the concrete, an insertion method of the reinforcing bar into the concrete, a construction method, and a cause of corrosion (neutralization, frost damage, construction defects, or the like) are not taken into account.

### Hardware configuration of peeling/flaking specification device

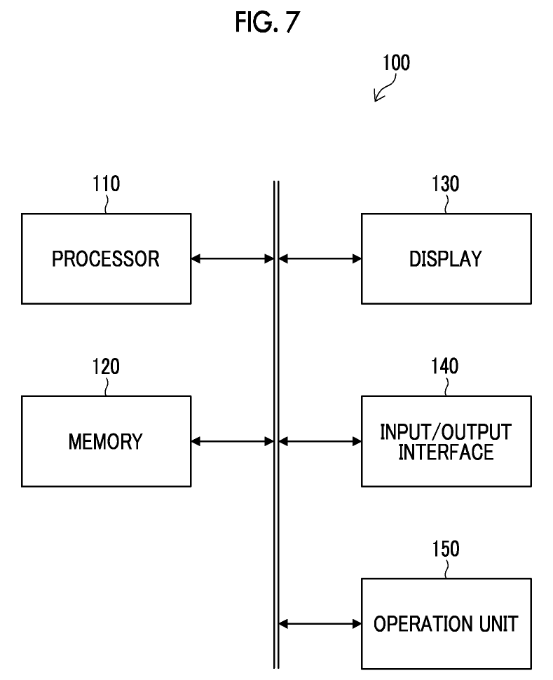

FIG. 7 is a block diagram showing an embodiment of a hardware configuration of the peeling/flaking specification device according to the present invention.

The peeling/flaking specification device 100 shown in FIG. 7 is configured of, for example, a personal computer, a workstation, or the like, and comprises a processor 110, a memory 120, a display 130, an input/output interface 140, and an operation unit 150. This peeling/flaking specification device 100 can be incorporated as one function of the data processing device 14 shown in FIG. 2.

The processor 110 is configured of a central processing unit (CPU) and the like, and integrally controls each unit of the peeling/flaking specification device 100 and executes a program for performing a peeling/flaking specification program to execute various types of processing for specifying the peeling/flaking portion on the surface of the building. Details of various types of processing performed by the processor 110 will be described below.

The memory 120 includes a flash memory, a read-only memory (ROM), a random access memory (RAM), a hard disk device, and the like. The flash memory, the ROM, or the hard disk device is a non-volatile memory that stores an operating system, various programs including the peeling/flaking specification program according to the embodiment of the present invention, and the like. Further, the non-volatile memory (storage device), such as flash memory and hard disk device, can store the three-dimensional measurement data of the surface of the building, which is measured by the three-dimensional measurement device 10 at the time of measurement start of the building and at the time of regular inspection, together with a measurement point in time.

The RAM functions as a work area for processing by the processor 110. Further, various programs stored in the flash memory or the like, the three-dimensional measurement data of the surface of the building, and the like are temporarily stored. A part (RAM) of the memory 120 may be built into the processor 110.

The display 130 displays a screen for operating the peeling/flaking specification device 100, displays surface data on design of the building, which is read out from the memory 120, or a captured image (including panorama composite image) of the building, which is captured by one of the stereo camera shown in FIG. 4 or another imaging device not shown, and further displays the peeling/flaking portion specified by the peeling/flaking specification device 100 in an identifiable manner on the surface data or the captured image.

The input/output interface 140 includes a connection unit that is connectable to an external device, a communication unit that is connectable to a network, and the like. A universal serial bus (USB), a high-definition multimedia interface (HDMI) (HDMI is a registered trademark), or the like can be employed as the connection unit that is connectable to the external device.

The peeling/flaking specification device 100 can be configured as a device independent of the data processing device 14. In this case, the processor 110 can acquire the three-dimensional measurement data of the surface of the building from the data processing device 14 via the input/output interface 140. Alternatively, in a case where the three-dimensional measurement data is stored in a cloud, the three-dimensional measurement data of the surface of the building can be acquired from the cloud via the input/output interface 140. Further, the processor 110 can store the three-dimensional measurement data acquired in this manner in the memory 120.

The operation unit 150 includes a pointing device such as a mouse, a keyboard, and the like, and uses a display screen of the display 130 to function as a part of a graphical user interface (GUI) that receives an instruction input by a user operation.

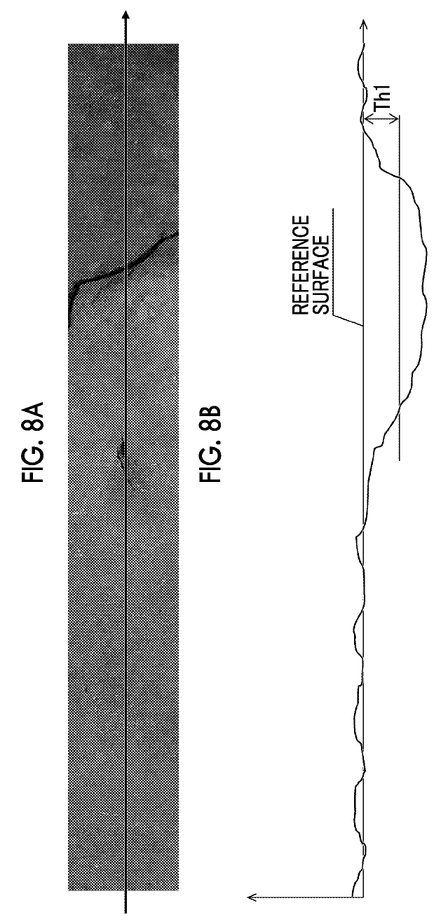

FIGS. 8A and 8B are diagrams showing a method for specifying the peeling/flaking portion on the surface of the building.

FIG. 8A is a diagram showing a surface of the building and a scanning line of laser light that scans the surface.

The three-dimensional measurement device 10 acquires the three-dimensional measurement data (point group data) of a large number of measurement points on the scanning line of the laser light.

The processor 110 compares the three-dimensional measurement data of the surface of the building with the reference surface data indicating a reference surface to detect the depressed portion on the surface of the building. That is, the reference surface data is subtracted from the three-dimensional measurement data to calculate height (unevenness) data of the surface of the building on the scanning line of the laser light.

FIG. 8B is a waveform diagram showing the height of the surface of the building obtained from the point group data on the scanning line.

As shown in FIG. 8B, a portion where the height data is negative (portion lower than the reference surface) is the depressed portion. The reference surface data indicating the reference surface can be defined in various ways, and can be surface data obtained by averaging unevenness of the surface of the building indicated by the three-dimensional measurement data, or the surface data on design of the building.

The processor 110 compares the depressed portion detected as described above with the first threshold value (Th1) to determine whether or not the depressed portion is depressed beyond the first threshold value (Th1). The first threshold value (Th1) is preferably set to a value that can eliminate the unevenness (depressed portion) of the surface at the time of construction of the building.

Next, the processor 110 determines whether the depressed portion exceeding the first threshold value (Th1) is the peeling/flaking portion or the fissuring.

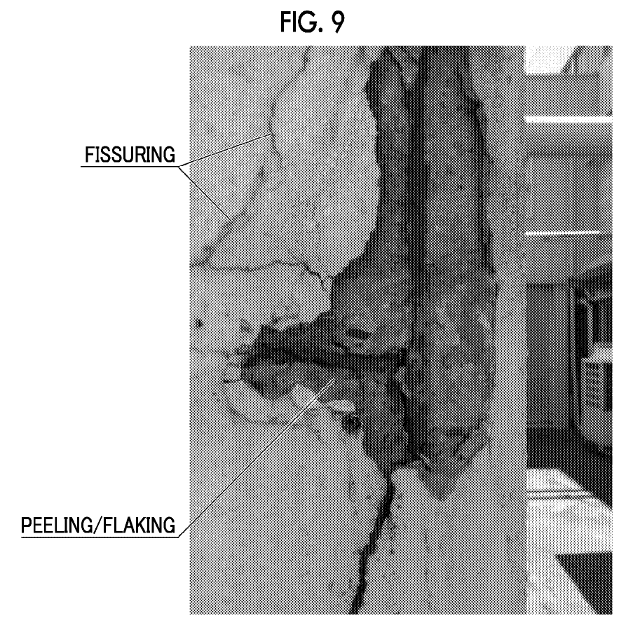

FIG. 9 is a captured image of a building including the peeling/flaking portion and a fissuring portion.

The peeling/flaking portion shown in FIG. 9 includes the fissuring portion. Further, the captured image shown in FIG. 9 also shows a single fissuring portion that is not included in the peeling/flaking portion.

FIG. 10 is a diagram showing an example of a surface property of a building, based on a large number of measurement points (measurement points distributed two-dimensionally) measured by the three-dimensional measurement device.

In FIG. 10, among the respective measurement points indicated by a point group, measurement points whose height data exceeds the first threshold value (Th1) are indicated by white circles, and measurement points whose height data is equal to or less than the first threshold value (Th1) are indicated by black circles.

Further, in FIG. 10, the measurement points indicated by white circles of 7 × 1 in a center portion correspond to the fissuring, and the measurement points indicated by white circles of 8 × 4 on a right side thereof correspond to the peeling/flaking portion. The depressed portion corresponding to the peeling/flaking portion contains the fissuring.

The processor 110 specifies the depressed portion as “peeling/flaking portion” (not “fissuring”) based on any one or more of the following determination results.

(1) A lateral width and a longitudinal width of the depressed portion are measured, and in a case where a short width of the lateral width or the longitudinal width exceeds a second threshold value (Th2), the depressed portion is specified as not being the fissuring (as the peeling/flaking portion).

The processor 110 detects a region of the depressed portion exceeding the first threshold value (Th1), from the height data of a large number of measurement points (measurement points distributed two-dimensionally) on the plurality of scanning lines by the measurement head of the three-dimensional measurement device 10. In the example shown in FIG. 10, the measurement points indicated by the white circles exceed the first threshold value (Th1), as described above.

The processor 110 measures the lateral width and the longitudinal width of a rectangle inscribed in the depressed portion exceeding the first threshold value (Th1), and in a case where a short width of the lateral width or the longitudinal width exceeds the second threshold value (Th2), the depressed portion is determined not to be the fissuring.

In the example shown in FIG. 10, the short width of the depressed portion indicated by the 7 × 1 white circle measurement points is a width corresponding to one measurement point and is equal to or less than the second threshold value (Th2), and thus the depressed portion is determined to be the fissuring (not to be the peeling/flaking portion). An interval between adjacent measurement points can be obtained in advance, based on a measurement distance to the surface of the building, a scanning speed of the three-dimensional measurement device 10, and the like.

On the other hand, the short width of the depressed portion indicated by the 8 × 4 white circle measurement points is a width equivalent to four measurement points, and in a case where the second threshold value (Th2) is set as a width equivalent to three measurement points, the width exceeds the second threshold value (Th2). Therefore, the depressed portion is determined not to be the fissuring (to be the peeling/flaking portion). The depressed portion indicated by the 8 × 4 white circle measurement points includes the fissuring portion, but there is no problem with the specification of the peeling/flaking portion described above.

FIG. 11 is a diagram showing another example of the surface property of the building based on two-dimensional measurement points measured by a three-dimensional measurement device.

In FIG. 11, the processor 110 measures a lateral width (W) and a longitudinal width (H) of a depressed portion (rectangle inscribed in a point group cluster indicated by white circles) exceeding the first threshold value (Th1). In the example shown in FIG. 11, the lateral width (W) is equivalent to a width of 12 measurement points, and the longitudinal width (H) is equivalent to a width of 10 measurement points.

In a case where a short width of the lateral width (W) and the longitudinal width (H) (the longitudinal width (H) in the example of FIG. 11) exceeds the second threshold value (Th2), the processor 110 determines that the depressed portion is not the fissuring (is the peeling/flaking portion).

(2) An area of the depressed portion is measured, and in a case where the area exceeds a third threshold value (Th3), the depressed portion is specified as not being the fissuring (as the peeling/flaking portion).

The processor 110 detects the region of the depressed portion exceeding the first threshold value (Th1) in the same manner as above. In a case where the area of the detected depressed portion (equivalent to the number of point groups in the depressed portion) exceeds the third threshold value (Th3), the depressed portion is determined not to be the fissuring.

(3) A captured image of the building captured by the imaging device is acquired, the fissuring in the building is detected based on the captured image, and the depressed portion is specified as not being the fissuring (as the peeling/flaking portion) based on a fissuring detection result.

The processor 110 acquires the captured image of the building captured by the imaging device, and detects the fissuring in the building based on the captured image. In a case where the depressed portion is determined not to be the fissuring from the fissuring detection result, the depressed portion is specified as the peeling/flaking portion. On the other hand, in a case where the depressed portion is determined to be the fissuring, determination can be made that the depressed portion is not the peeling/flaking portion. The method for detecting the fissuring from the captured image is well known, and it is possible to detect the fissuring more appropriately by using a captured image with high resolution rather than the three-dimensional measurement data.

### Another method for detecting depressed portion on surface of building

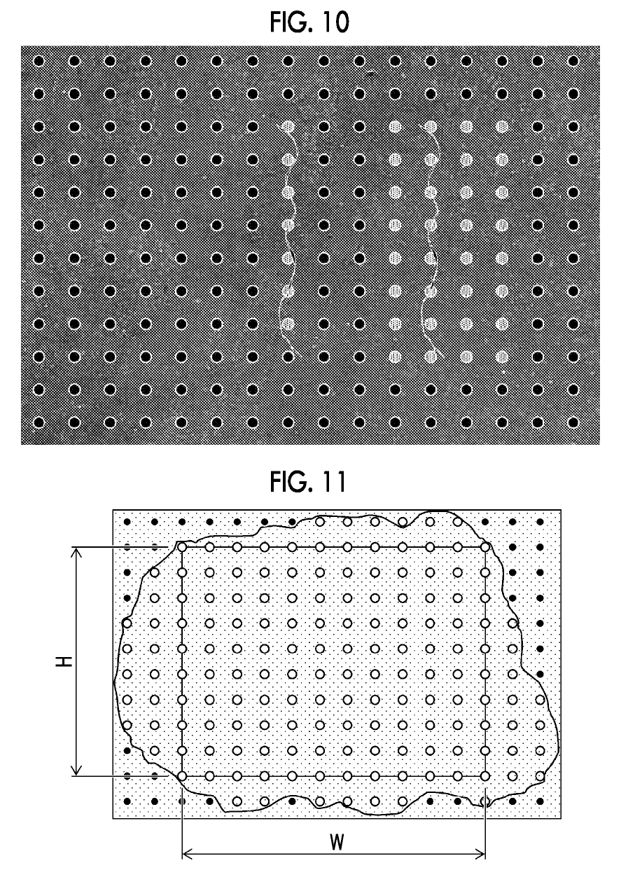

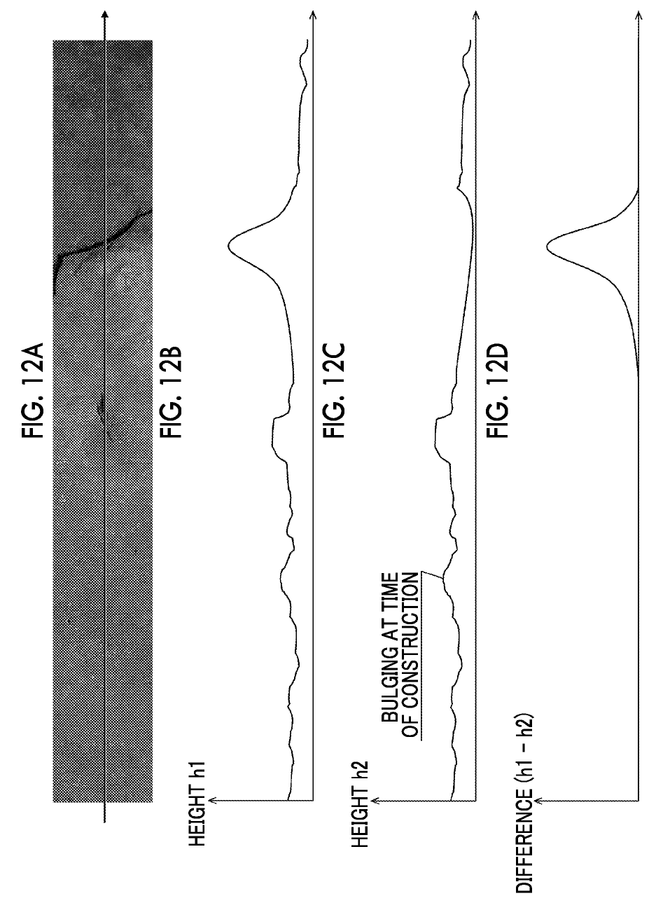

FIGS. 12A, 12B, 12C and 12D are diagrams showing another method for detecting the depressed portion on the surface of the building.

FIG. 12A is a diagram showing the surface of the building and the scanning line of the laser light that scans the surface thereof, as in FIG. 8A.

The three-dimensional measurement device 10 acquires the three-dimensional measurement data of a large number of measurement points on the scanning line of the laser light. The memory 120 stores the three-dimensional measurement data of the surface of the building, which is measured by the three-dimensional measurement device 10 each time the building is inspected.

FIG. 12B is a waveform diagram showing a height (h1) of the surface of the building at a certain time of inspection T1. The height (h1) of the surface of the building shown in FIG. 12B is acquired based on the three-dimensional measurement data on the scanning line shown in FIG. 12A that is measured at the time of inspection T1.

FIG. 12C is a waveform diagram showing a height (h2) of the surface of the building at a time of inspection T2, which is later than the time of inspection T1. The height (h2) of the surface of the building shown in FIG. 12C is acquired based on the three-dimensional measurement data on the scanning line shown in FIG. 12A that is measured at the time of inspection T2.

FIG. 12D is a waveform diagram showing a difference (h1 - h2) at the same measurement point on the surface of the building, which is obtained by subtracting the height (h2) of the surface of the building at the time of inspection T2 shown in FIG. 12C from the height (h1) of the surface of the building at the time of inspection T1 shown in FIG. 12B.

In a case where the difference (h1 - h2) is positive, the surface of the building is low (depressed) by the difference (h1 - h2) during a period from the time of inspection T1 to the time of inspection T2. Conversely, in a case where the difference (h1 - h2) is negative, the surface of the building is high (bulged) by the difference (h1 - h2) during the period from the time of inspection T1 to the time of inspection T2.

With the acquisition of the difference data of the same measurement point on the surface of the building based on a plurality of pieces of three-dimensional measurement data measured at respective inspection times, the processor 110 can detect a bulging portion and the depressed portion on the surface of the building, and can detect, in a case of the present example, the depressed portion on the surface of the building from the positive difference data.

Among the different pieces of three-dimensional measurement data at the time of inspection used to acquire the difference data, early three-dimensional measurement data at the time of inspection serves as the reference surface data for late three-dimensional measurement data at the time of inspection.

### Another method for specifying peeling/flaking portion

In the above embodiment, the three-dimensional measurement data of the surface of the building is compared with the reference surface data of the building to detect the depressed portion on the surface of the building, and the property of the detected depressed portion is analyzed to specify the peeling/flaking portion on the surface of the building. However, the present invention is not limited to the analysis of the property of the depressed portion. Alternatively, in addition to the analysis of the property of the depressed portion, the difference data may be obtained based on a plurality of pieces of three-dimensional measurement data of the surface of the building acquired at times of a plurality of (three or more) inspections as shown below, and the peeling/flaking portion may be specified from a change in the difference data.

In a case where the bulging portion and the depressed portion at the same portion on the surface of the building are detected in a chronological order of the inspection based on the difference data, the processor 110 specifies the depressed portion as the peeling/flaking portion on the surface of the building. That is, in a case where the bulging on the surface of the building is detected based on the difference data and then the detected bulging portion is detected as the depressed portion, the depressed portion is specified as the peeling/flaking portion. This is because the bulging portion is considered to be peeled and flaked.

Further, in a case where changes in a plurality of pieces of difference data of the building turn negative (in a case where the change in the difference data in a case where the surface of the building bulges is set to be positive and the change in the difference data in a case where the surface of the building is depressed is set to be negative, the change in difference data turns negative), the processor 110 specifies the depressed portion whose difference data turns negative as the peeling/flaking portion on the surface of the building.

Furthermore, in a case where the change in the difference data turns from positive to negative, or in a case where the change in the difference data decreases beyond a threshold value, the processor 110 can specify the depressed portion corresponding to these changes in the difference data as the peeling/flaking portion on the surface of the building.

### Display of peeling/flaking portion

In a case where the peeling/flaking portion on the surface of the building is specified, the processor 110 displays the specified peeling/flaking portion on a screen of the display 130 such that the user can check the peeling/flaking portion.

The processor 110 can display, on the display 130, the measured three-dimensional measurement data, the surface data on design of the building, or the captured image of the building captured by the imaging device, but the specified peeling/flaking portion is preferably displayed in an identifiable manner on the screen of the display 130 that displays these pieces of data or the captured image.

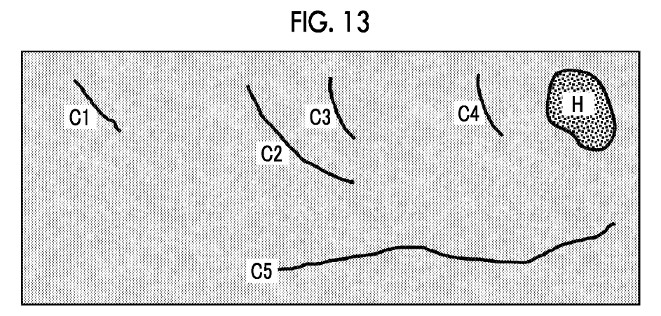

FIG. 13 is a diagram showing an example of a screen of a display on which the peeling/flaking portion and the like are displayed.

The screen of the display 130 shown in FIG. 13 displays a peeling/flaking portion (H) and fissuring portions (C1 to C5) in a superimposed manner on the captured image of the surface of the building.

The peeling/flaking portion (H) is displayed in a brightness or color different from that of the captured image of the surface of the building or the like in the background, and thus is displayed in an easily identifiable manner for the user. The detected fissuring portions (C1 to C5) are also highlighted on the screen of the display 130, but the detection of the fissuring portions (C1 to C5) and the highlighted display of the fissuring portions (C1 to C5) are not necessarily required. Further, the captured image displayed on the display 130 may also be a panorama image obtained by performing the panorama composition on a plurality of captured images.

### Peeling/flaking specification method

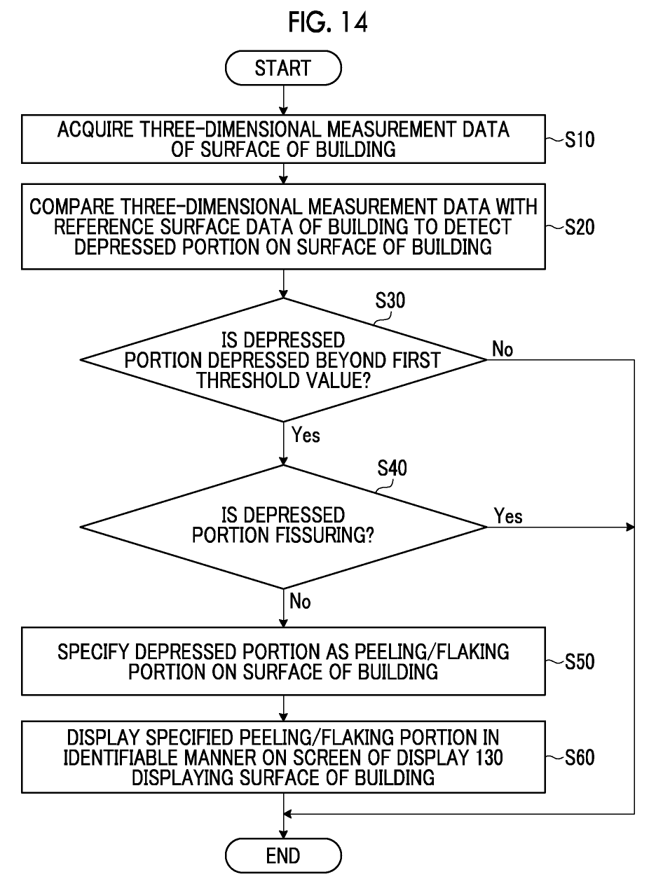

FIG. 14 is a flowchart showing an embodiment of a peeling/flaking specification method according to the present invention.

The peeling/flaking specification method shown in FIG. 14 is performed by the processor 110 of the peeling/flaking specification device 100 shown in FIG. 7.

In FIG. 14, the processor 110 acquires the three-dimensional measurement data measured by the three-dimensional measurement device 10 (refer to FIG. 3) each time the building is inspected (step S10). The processor 110 may acquire the three-dimensional measurement data, from the storage device of the data processing device 14, the cloud, or the like, or from the memory 120 of the peeling/flaking specification device 100.

The processor 110 compares the three-dimensional measurement data with the reference surface data of the building to detect the depressed portion on the surface of the building (step S20). The three-dimensional measurement data having the height lower than that of the reference surface data can be detected as data of the depressed portion.

Subsequently, the processor 110 determines whether or not the depressed portion detected in step S20 is depressed beyond the first threshold value (step S30). This is to distinguish the detected depressed portion from the depressed portion that is present from the time of construction (depressed portion caused by slight unevenness).

In a case where the depressed portion is determined to be depressed beyond the first threshold value (in case of “Yes”), the processing proceeds to step S40. In a case where the depressed portion is determined not to be depressed beyond the first threshold value (in case of “No”), the depressed portion is determined not to be the peeling/flaking portion, and the determination of the surface property for the depressed portion is ended.

In step S40, the processor 110 determines whether or not the depressed portion that is depressed beyond the first threshold value is the fissuring. Specifically, the following processing is performed to determine whether the depressed portion is the peeling/flaking portion or the fissuring portion.

(1) The lateral width and the longitudinal width of the depressed portion are measured, and in a case where the short width of the lateral width or the longitudinal width exceeds the second threshold value (Th2), the depressed portion is determined not to be the fissuring.

(2) The area of the depressed portion is measured, and in a case where the area exceeds the third threshold value (Th3), the depressed portion is determined not to be the fissuring.

(3) The captured image of the building captured by the imaging device is acquired, the fissuring in the building is detected based on the captured image, and the depressed portion is determined not to be the fissuring based on the fissuring detection result.

In a case where the depressed portion is determined not to be the fissuring portion in step S40 (in case of “No”), the processor 110 specifies the depressed portion as the peeling/flaking portion on the surface of the building (step S50).

The processor 110 issues a notification of the specified peeling/flaking portion on the surface of the building (step S60). For example, the processor 110 displays the specified peeling/flaking portion (H) in an identifiable manner on the screen of the display 130 displaying the surface of the building (refer to FIG. 13).

Accordingly, it is possible for the inspector to easily check the peeling/flaking portion on the surface of the concrete or the like of the building.

### Other

The building of the present embodiment is the tunnel, but the present invention is not limited thereto. Any building may be employed as long as the building is subjected to inspection, such as a bridge or a dam. The material of the surface of the building includes concrete repair materials such as reinforced concrete, concrete, and mortar.

In the present embodiment, for example, a hardware structure of a processing unit that executes various types of processing, such as a central processing unit (CPU), includes the following various processors. The various processors include: a CPU that is a general-purpose processor functioning as various processing units by executing software (programs); a programmable logic device (PLD) that is a processor of which the circuit configuration can be changed after manufacture, such as a field programmable gate array (FPGA); a dedicated electric circuit that is a processor having a circuit configuration designed exclusively to perform specific processing, such as an application specific integrated circuit (ASIC); and the like.

One processing unit may be configured of one of these various processors or may be configured of two or more processors of the same type or different types (for example, a plurality of FPGAs or a combination of CPU and FPGA). Further, a plurality of processing units may be configured by one processor. As an example of configuring the plurality of processing units by one processor, first, there is a form in which one processor is configured of a combination of one or more CPUs and software, as represented by a computer such as a client or a server, and the one processor functions as the plurality of processing units. Second, there is a form in which a processor that realizes the functions of the entire system including the plurality of processing units by one integrated circuit (IC) chip is used, as represented by a system on chip (SoC) or the like. In this manner, the various processing units are configured using one or more of the various processors as the hardware structure.

Further, as the hardware structure of the various processors, more specifically, an electric circuit (circuitry) in which circuit elements such as semiconductor elements are combined may be used.

Furthermore, the present invention includes the peeling/flaking specification program that is installed on a computer to cause the computer to function as the peeling/flaking specification device of the present invention, and a non-volatile storage medium on which this peeling/flaking specification program is recorded.

Further, it is needless to say that the present invention is not limited to the embodiments described above and various modifications can be made within a range not departing from the spirit of the present invention.

### Explanation of References

10: three-dimensional measurement device 12: tripod 14: data processing device 16: power supply device 18: carriage 20: wall surface 30L: left camera 30R: right camera 40: reinforcing bar 50: reactive aggregate 60: steel material 100: peeling/flaking specification device 110: processor 120: memory 130: display 140: input/output interface 150: operation unit S10 to S60: step

What is claimed is:

1. A peeling/flaking specification device comprising:
a processor; and
a memory that stores a program to be executed by the processor,
wherein the processor is configured to:
acquire three-dimensional measurement data of a surface of a building measured by a measurement device;
compare the three-dimensional measurement data with reference surface data of the building to detect a depressed portion on the surface of the building; and
specify, in a case where determination is made that the depressed portion is depressed beyond a first threshold value and the depressed portion is not fissuring, the depressed portion as a peeling/flaking portion on the surface of the building.

2. The peeling/flaking specification device according to claim 1,
the processor being configured to:
measure a lateral width and a longitudinal width of the depressed portion, and determine that the depressed portion is not the fissuring in a case where a short width of the lateral width or the longitudinal width exceeds a second threshold value.

3. The peeling/flaking specification device according to claim 1,
the processor being configured to:
measure an area of the depressed portion, and determine that the depressed portion is not the fissuring in a case where the area exceeds a third threshold value.

4. The peeling/flaking specification device according to claim 1,
the processor being configured to:
acquire a captured image of the building captured by an imaging device;
detect the fissuring in the building based on the captured image; and
determine whether or not the depressed portion is the fissuring based on a detection result of the fissuring.

5. The peeling/flaking specification device according to claim 1,
the reference surface data being surface data obtained by averaging unevenness of the surface of the building indicated by the three-dimensional measurement data, or surface data on design of the building.

6. The peeling/flaking specification device according to claim 1,
the memory storing the three-dimensional measurement data of the surface of the building measured by the measurement device each time the building is inspected, and
the processor being configured to:
acquire a plurality of pieces of three-dimensional measurement data of the surface of the building measured for each inspection;
acquire difference data of the same measurement point on the surface of the building based on the plurality of pieces of three-dimensional measurement data; and
detect at least the depressed portion of a bulging portion or the depressed portion on the surface of the building based on the difference data.

7. The peeling/flaking specification device according to claim 6,
the processor being configured to:
specify, in a case where the bulging portion and the depressed portion at the same portion on the surface of the building are detected in a chronological order of the inspection, the depressed portion as the peeling/flaking portion on the surface of the building.

8. The peeling/flaking specification device according to claim 6,
the processor being configured to:
specify, in a case where a change in the difference data turns negative, in a case where the change in the difference data turns from positive to negative, or in a case where the change in the difference data decreases beyond a threshold value, the depressed portion as the peeling/flaking portion on the surface of the building.

9. The peeling/flaking specification device according to claim 1,
the processor being configured to:
display the specified peeling/flaking portion in an identifiable manner on a screen of a display that displays the three-dimensional measurement data, surface data on design of the building, or a captured image of the building captured by an imaging device.

10. The peeling/flaking specification device according to claim 1,
the measurement device including a LiDAR or a stereo camera.

11. The peeling/flaking specification device according to claim 10,
the three-dimensional measurement data being measured by the LiDAR of a frequency modulated continuous wave (FMCW) type.

12. The peeling/flaking specification device according to claim 1,
a material of the surface of the building including concrete or a concrete repair material.

13. A peeling/flaking specification method for specifying peeling/flaking on a surface of a building by a processor, the method comprising:
acquiring three-dimensional measurement data of a surface of a building measured by a measurement device;
comparing the three-dimensional measurement data with reference surface data of the building to detect a depressed portion on the surface of the building; and
specifying, in a case where determination is made that the depressed portion is depressed beyond a first threshold value and the depressed portion is not fissuring, the depressed portion as a peeling/flaking portion on the surface of the building.

14. The peeling/flaking specification method according to claim 13,
the processor being configured to:
measure a lateral width and a longitudinal width of the depressed portion, and determine that the depressed portion is not the fissuring in a case where a short width of the lateral width or the longitudinal width exceeds a second threshold value.

15. The peeling/flaking specification method according to claim 13,
the processor being configured to:
measure an area of the depressed portion, and determine that the depressed portion is not the fissuring in a case where the area exceeds a third threshold value.

16. The peeling/flaking specification method according to claim 13,
the processor being configured to:
acquire a captured image of the building captured by an imaging device;
detect the fissuring in the building based on the captured image; and
determine whether or not the depressed portion is the fissuring based on a detection result of the fissuring.

17. A non-transitory, computer-readable tangible recording medium on which a program for causing a processor of a computer to execute the peeling/flaking specification method according to claim 13 is recorded.
